(19) United States
(12) Patent Application Publication
(10) Pub. No.: US 2002/0111999 A1
(43) Pub. Date: Aug. 15, 2002

(54) System and method for remote control of software and an attached device

(76) Inventor: Anders Jorgen Mikael Andersson, San Jose, CA (US)

Correspondence Address: LAW OFFICE OF THOMAS SCHNECK, P.O. BOX 2-E, SAN JOSE, CA, 95109-0005, US

(21) Appl. No.: 09/902,223

(22) Filed: Jul. 9, 2001

Related U.S. Application Data
(60) Provisional application No. 60/268,592, filed on Feb. 13, 2001.

(51) Int. Cl. G06F 15/16

(52) U.S. Cl. 709/203; 709/217

(57) ABSTRACT

A system and method for remotely controlling a software application and, where applicable, a hardware or software device attached to the host computer. An internet connection native to the application is established between a host and one or more remote computers running the same software application. This connection enables a remote viewer to view and control the host user's application via the application's graphical user interface. The host user retains control of the application at all times.

### CROSS-REFERENCE TO RELATED APPLICATION

This application claims priority from U.S. provisional application No. 60/268,592, filed Feb. 13, 2001.

### FIELD OF THE INVENTION

This invention relates to customer support within the computer and software industry and collaboration between geographically remote computer users. This invention particularly relates to the remote control of a software application and, where applicable, a hardware or software device attached to the host computer.

### BACKGROUND OF THE INVENTION

The growth of the Internet allows computers all over the world to be connected to one another via various networks. These connections allow computer users to communicate with one another for both business and personal reasons. It is also possible for one remotely-located user to view and control a host-user's computer. (In this application, the term “host” refers to the computer containing the software and, where applicable, the device whose control is shared with another “remote” computer.) Remote access and control of computers is useful for transferring files and system administration. It can also provide an opportunity for geographically separated coworkers to collaborate on projects. Computer-to-computer customer service and technical support are also enabled by remote access and control technology.

The remote-control collaboration/customer support technology would be particularly useful in the development of microcontrollers, integrated chips designed to control specific systems. Microcontrollers run application-specific software which engineers must debug during the hardware/software integration phase of development. Emulators, such as those available from NOHAU Corporation, have been developed to simplify the debugging process by providing engineers an interface to the microcontroller. The microcontroller is attached to the engineer's computer as a hardware device; the engineer can then run the application-specific software intended for the microcontroller and debug the software and validate the integrated (hardware and software) microcontroller design. Given the technical details involved in running these emulators, a high level of technical support is desirable. It would be very useful for a technical support specialist at a remote location to be able to view the customer's monitor and control the customer's software application and the attached device. Similarly, a system where collaborating engineers could remotely view and control an emulator running on a host computer would also be very useful. The current invention seeks to improve upon the prior art relating to remote control of software applications.

The Telnet protocol allows remote access of a host computer. Remote users may access the host computer via telnet, a text-based protocol, as long as they can successfully log in with a user ID and password. Upon successfully logging in, the remote user can access specific applications or data located on the host computer.

Remote users may request files from other computers via other protocols such as the File Transfer Protocol (FTP) and the Hypertext Transfer Protcol (HTTP). However, these protocols grant access to files only, not the entire computer.

U.S. Pat. No. 5,909,545 “Method and System for On Demand Downloading of Module to Enable Remote Control of an Application Program over a Network” discloses a method of demonstrating and remotely controlling software over a network via a remote display module transported from a host computer to a guest computer. The remote display module is executed at the guest's computer to establish communication between the interface to computer resources at the guest's and host's computer. The application and an application interception module are launched at the host computer to establish communication between the application interception module and the remote display module. This allows I/O messages to be communicated between the application and the user interface at the guest computer. The remote display module converts remote control messages and responses to a format understood by the host application and the guest computer, allowing output to be provided to the guest and the guest's input to be provided to the host application. The preferred embodiment is to present the modules and application program through HTTP servers to a guest system which uses a browser having a JAVA interpreter to execute the remote display module and convert the remote control protocol messages.

U.S. Pat. No. 5,801,689 “Hypertext Based Remote Graphic User Interface Control System” and U.S. Pat. No. 5,949,412 “Computer Remote Control System” disclose a method of controlling a remote computer via the World Wide Web. There are two main components of these inventions—a GUI-screen-to-hypertext converter and a hypertext-to-GUI response means. These two components allow the host computer's screen to appear in a web page where it can be controlled by the remote user.

There are some commercial remote control software products. These products include PC Anywhere, Laplink, Carbon Copy, and Double Vision. These products control the entire computer, not a single application. In addition, these are “external” applications which will operate slower than a solution that is native to the software application being used by the host and remote users. None of these products is able to remotely control a hardware device attached to a host computer.

There is no discussion in the prior art of how to remotely control a single application rather than the entire computer. Similarly, there is no discussion of how to remotely control a hardware device attached to a host user's computer. There is also no discussion of how to enable remote control of a host computer by a remote computer without compromising the host organization's internet security. The prior art also does not discuss how to accommodate “double control” where both the host and remote users can control the device. Finally, there is no discussion of remote control of a computer or software application without the use of HTML, an Internet browser, or operating system-related messages.

It is an object of the invention to enable remote control of a software application via communication that is native to the application.

It is an object of the invention to enable remote control of a software application by a remote user in another organization that does not compromise the host organization's Internet security.

It is another object of the invention to enable remote control of a single software application that does not require control of the entire host computer.

It is another object of the invention to enable remote control of a software application without relying on HTML, an Internet browser, and operating system-related commands or messages.

It is an object of the invention to enable a remote computer user to view and control software running on a host computer.

It is another object of this invention to enable a remote computer user to view and control software and a hardware device controlled by the software which is running on a host computer.

It is another object of this invention to provide an improved approach to customer support for software applications.

It is another object of this invention to provide an improved method for collaborations among users of a particular software application.

### SUMMARY OF THE INVENTION

This invention provides a system and method that allows both a remote computer user and a host computer user to view and control a software application running on a host computer. In instances where the host's software application controls a device connected to the host computer, the invention enables the remote user to view and control the operations of that device.

The host and remote computers share information and control of the software and attached device via the software application's graphical user interface. The host and remote applications are linked via a TCP/IP connection between the software applications. Using this approach, only the applications, and not the computers as a whole, are linked.

Before a connection can be established, one of the software applications should be configured as “client-side” and one should be configured as “server-side.” (The terms “client” and “server” have their usual definitions in this application, i.e., a client requests the services of and accepts the responses of a server.) If the host, but not the remote user, is located behind a firewall, the host's software should be configured as “client-side” while the remote computer's software should be configured as “server-side” since the remote user would ordinarily not be able to initiate the connection due to the firewall.

The invention allows multiple users whose software application is configured to be client-side to be connected simultaneously to a computer configured as a server. The device the software application controls can be attached either to the server or to any of the clients.

Once a connection is established, any action performed by either the host or remote application will control the other side of the connection as well as any hardware device that may be connected to one of the computers. In addition, when a hardware device is connected to one of the computers, all device events can be monitored via the graphical user interface of the host and remote applications.

### BRIEF DESCRIPTION OF THE DRAWINGS

FIG. 1 is a block diagram showing the configuration of a customer support system in accordance with the invention.

FIG. 2 is a diagram showing the components of the host and remote software applications in accordance with the invention of FIG. 1.

FIG. 3 is a flowchart showing how commands issued by a host user may be viewed by a remote user in accordance with the invention.

FIG. 4 is a flowchart showing how commands issued by a remote user may be viewed by the host user in accordance with the invention.

FIG. 5 is a block diagram showing the configuration for a customer linked to two support computers in accordance with the invention.

FIG. 6 is a block diagram showing a possible configuration for geographically remote collaborators who are linked via a software application in accordance with the invention.

### DETAILED DESCRIPTION OF THE INVENTION

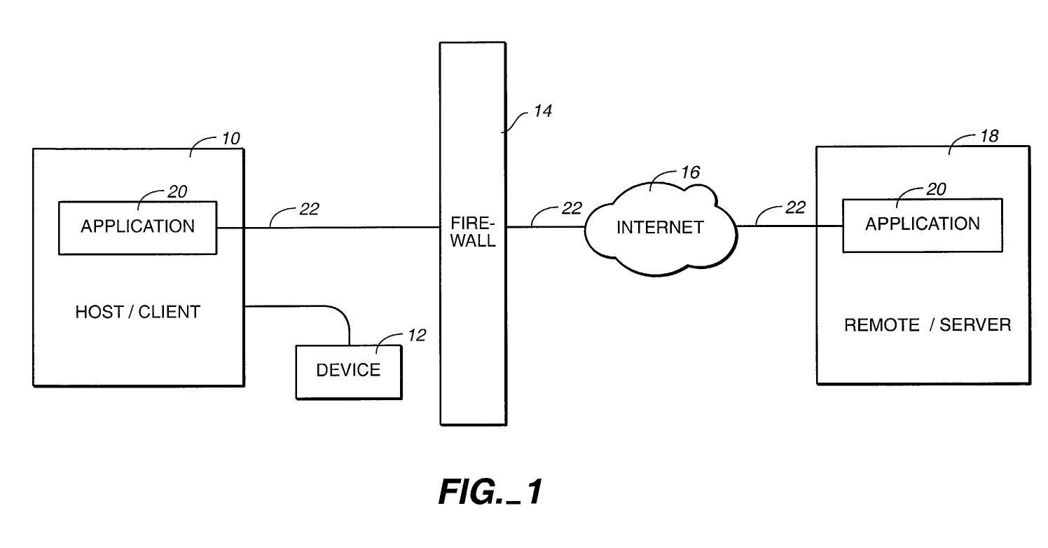

With reference to FIG. 1, host computer 10, running a software application 20 which controls the attached device 12, is located behind a firewall 14. Possible devices 12 include a hardware device such as an in-circuit emulator, a microprocessor, a data storage device, a test instrument, or an internet-enabled device. A software device such as a simulator may also be attached. The host 10 user decides to seek help from a customer support specialist who is at a remote computer 18. The term “host” will refer to the software application being viewed and controlled by another software application. The term “remote” will refer to the application viewing and controlling the host application. Remote computer 18 has a copy of the same software application 20 that is running on the host computer 10. In order to get help from the customer support specialist at remote computer 18, the user at the host computer 10 initiates a connection 22 via the Internet 16 between the host computer 10 software application 20 and the remote computer 18 application 20.

In the customer support context, a connection between a customer and a support specialist must be established. If a customer is behind a firewall, the customer's application must be configured as client-side software; the support specialist's application must therefore be configured as server-side software. Although FIG. 1 shows the device 12 attached to the computer whose application is configured as a client, the device 12 could be attached to a computer whose application is configured as a server. Only one device 12 may be attached to the application-linked computers. The only time an application must be configured as client-side software is if the computer on which it is running is behind a firewall or a similar security device. An application installed on a computer which is behind a firewall or similar security device cannot be designated as a server unless the IP address requesting a connection has permission to get behind the firewall (i.e., the source address is acceptable).

The customer will establish a connection by choosing the “Support Over IP” option from the “Help” menu, entering the support computer's IP address, and requesting that an optional password-protected connection be established. A TCP/IP connection is established between the two applications. Any action by either of the applications will control the application on the other side of the connection as well as the hardware device attached to the customer's computer. Either the customer or the support technician may terminate the connection at any time.

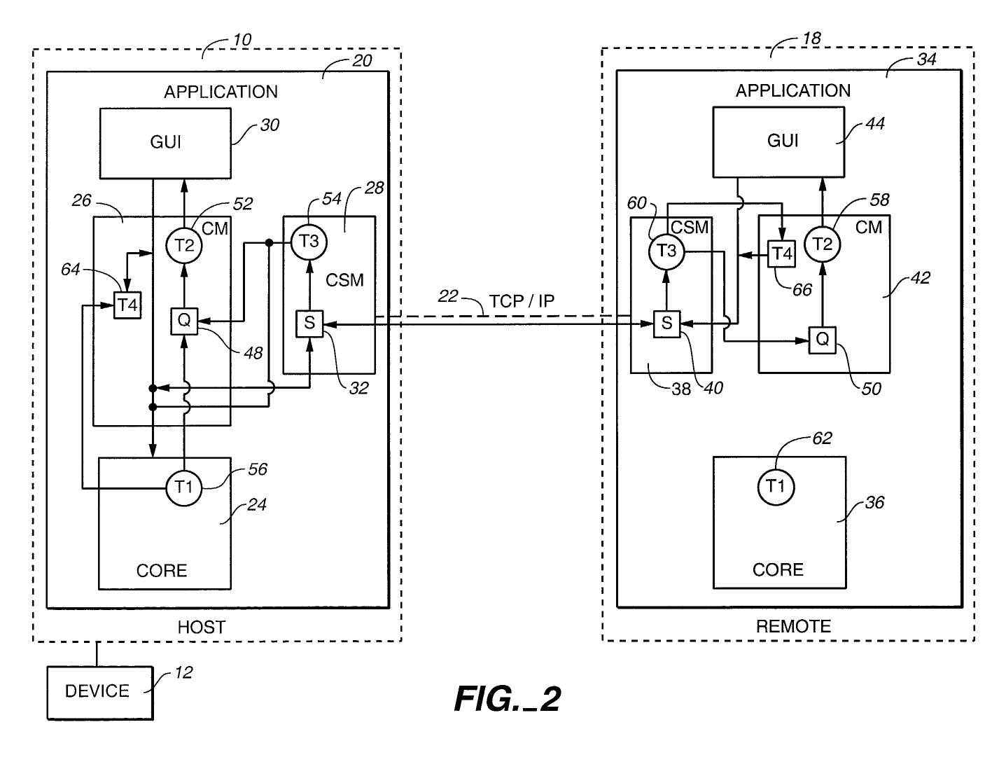

In FIG. 2, a host (customer) computer 10 and a remote (support) computer 18 are running the same instances of a software application 20, 34 which have the same components but are configured slightly differently. Arrows indicate the paths messages may take within and between the components of the applications 20, 34. The two software applications 20, 34 are connected via a TCP/IP connection 22. A hardware or software device 12 may be attached to the host computer 10. In the host application 20, a core component 24 contains most of the code for the software's operations and, where a hardware or software device 12 is attached to the computer 10, controls the hardware or software device 12. A transmit thread (T1) 56 in the core component 24 sends commands back to the graphical user interface (GUI) 30 which allows the viewer to input commands or view the output of the application 20. A communication module (CM) 26 is responsible for passing messages between the core component 24 and the graphical user interface 30. A queue (Q) 48 in the communication module 26 holds messages to be passed to the graphical user interface 30, while a thread (T2) 52 takes messages from the queue 48 and passes them to the graphical user interface 30. Messages can include commands, requests for information, replies to requests, and notifications of events that have occurred to the hardware or software device 12, if any is attached. The application 20 also contains a client/server module (CSM) 28. The client/server module has a socket (S) 32 which allows for bi-directional communication between applications. A read thread (T3) 54 takes messages out of the socket 32.

The remote computer 18 application 34 contains the same components with similar functions. A core component 36 contains much of the code for the software application 34. The core component 36 also contains a transmit thread (T1) 62 for sending messages from the core component 36; however, when the application 34 is connected to the host application 20, neither the core component 36 or the transmit thread 62 are employed since the host application's 20 core component 24 is active. A graphical user interface (GUI) 44 is included along with a communication module (CM) 42 (containing a queue (Q) 50 and a thread (T2) 58 for taking messages from the queue 50 to the graphical user interface 44) and a client/server module (CSM) 38 which contains a socket (S) 40 allowing bi-directional communication between applications. A read thread (T3) 60 takes messages out of the socket 40 and passes them to the queue 50 in the communication module 42.

When the applications 20, 34 are connected, both the host and remote graphical user interfaces 30, 44 can send two types of commands to the host core component 24. These are: 1) non-wait commands, which are transmitted to provide some instruction to either the core component 24 or the hardware device 12 that may or may not return a result at a future time; and 2) wait commands, which are transmitted and require an answer before the applications 20, 34 are allowed to continue their execution. A time-out can be set for a wait command. Where wait commands are issued by the graphical user interfaces 20, 34, the core component 24 must respond before other operations can occur. A blocking thread (T4) 64 in the host communication module and a blocking thread (T4) 66 in the remote communication module will monitor whether the core component 24 has responded to a wait command.

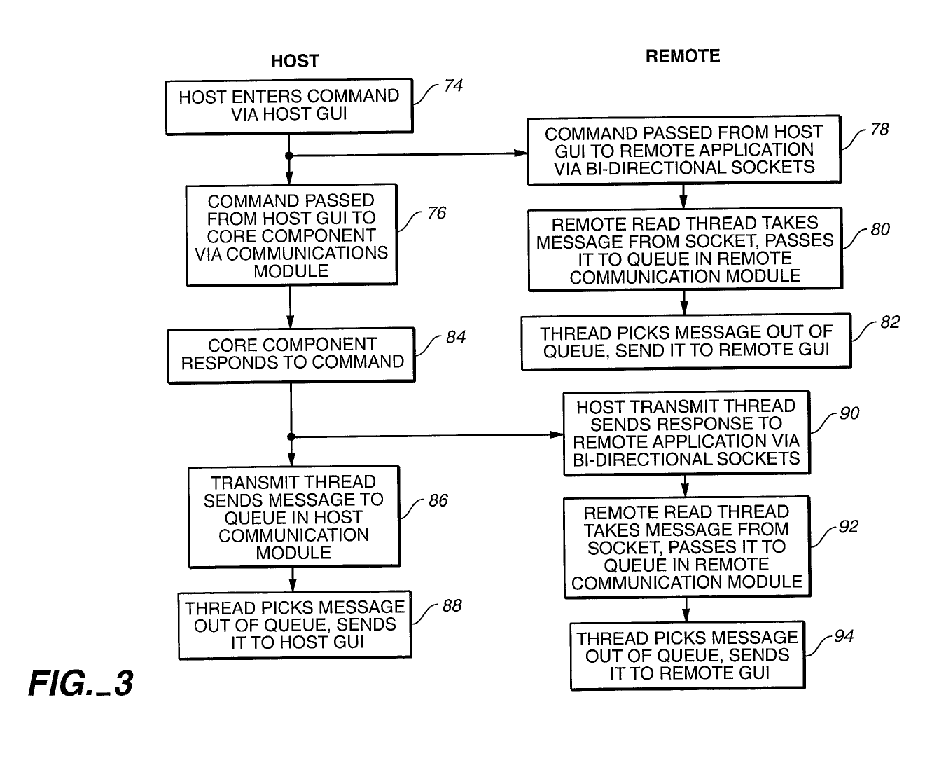

With reference to FIG. 3, commands entered by the host user may be viewed by the remote user after a connection between the two applications is established. Reference is also made to FIG. 2. The host user enters a command via the host graphical user interface 30 (step 74). This command is sent from the host graphical user interface 30 to the host core component 24 via the host communications module 26 (step 76); at the same time, the command is passed from the host graphical user interface 30 to the remote application 34 via the bi-directional sockets 32, 40 (step 78). The remote read thread 60 takes the message from the socket 40 and passes it to the queue 50 in the remote communication module 42 (step 80). A thread 58 picks the message out of the queue 50 and sends it to the remote graphical user interface 44 (step 82). The remote user is now able to view the action taken by the host user.

When the host core component 24 responds to the command sent by the host graphical user interface 30 (step 84), a transmit thread 56 sends the message to a queue 48 in the host communication module 26 (step 86). Another thread 52 then picks the message out of the queue 48 and sends it to the host graphical user interface 30 (step 88), thus notifying the host user that the command has been carried out. At the same time steps 86 and 88 are carried out, the remote user is also notified. The host transmit thread 56 sends a response to the remote application 34 via the bi-directional sockets 40, 32 (step 90). The remote read thread 60 takes this message from the socket 40 and passes it to the queue 50 in the remote communications module 42 (step 92). A thread 58 picks this message out of the queue 50 and sends it to the remote graphical user interface 44 (step 94). This informs the remote user of the response to the command.

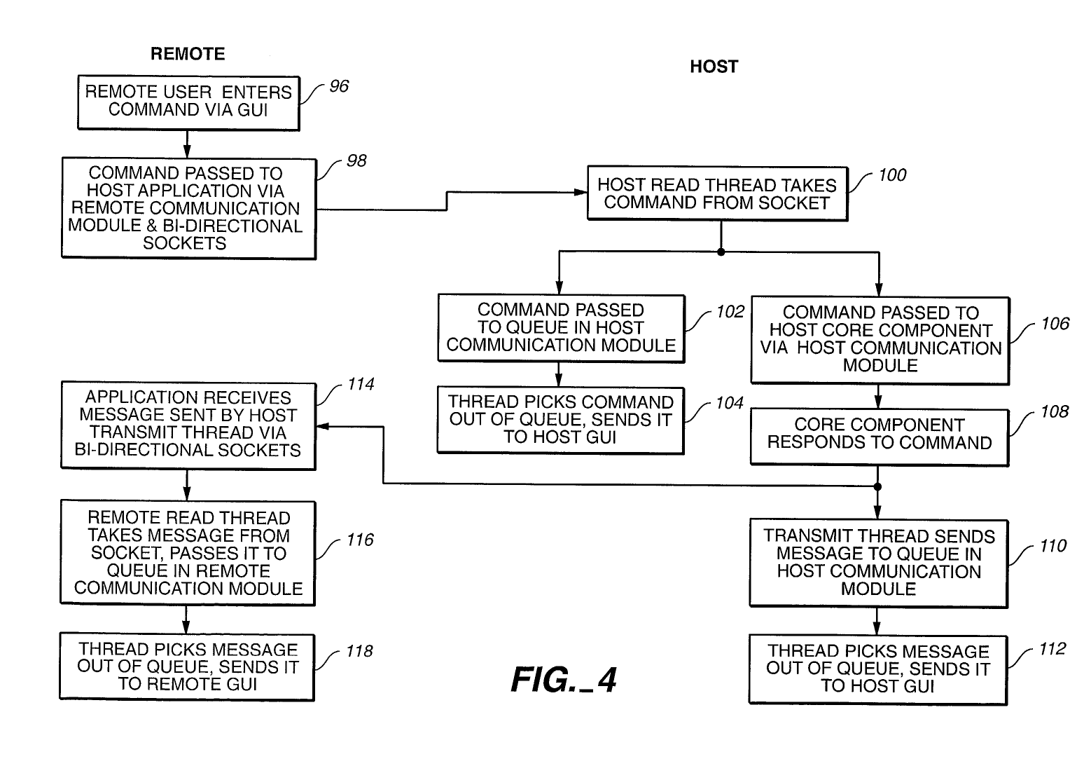

With reference to FIG. 4, commands entered by the remote user are relayed to the host application and may be viewed by the host user after a connection between the two applications is established. Reference is also made to FIG. 2. A remote user enters a command via the remote application's 34 graphical user interface 44 (step 96). The command is passed to the host application 20 via the remote communication module 42 and bi-directional sockets 40, 32 (step 98). The host read thread 54 then takes the command from the socket 32 (step 100). The command is passed to the queue 48 in the host communication module 26 (step 102) where a thread 52 picks the command out of the queue 48 and sends it to the host graphical user interface 30 (step 104). This allows the host user to view the remote user's activity. While steps 102 and 104 are carried out, the command is also passed from the socket 32 to the host core component 24 via the host communication module 26 (step 106).

The host core component 24 responds to the command (step 108). Both the remote and host users will then receive a message from the host core component 24. The host transmit thread 56 sends a message to the queue 48 in the host communication module 26 (step 110). The message is picked out of the queue 48 by a thread 52 and sent to the host graphical user interface 30 (step 112). While steps 110 and 112 are carried out, the remote application 34 receives a message sent by the host transmit thread 56 via the bi-directional sockets 32, 40 (step 114). The remote read thread 60 takes the message from the socket 40 and passes it to the queue 50 in the remote communication module 42 (step 116). The thread 58 picks the message out of the queue 50 and sends it to the remote graphical user interface 44 (step 118).

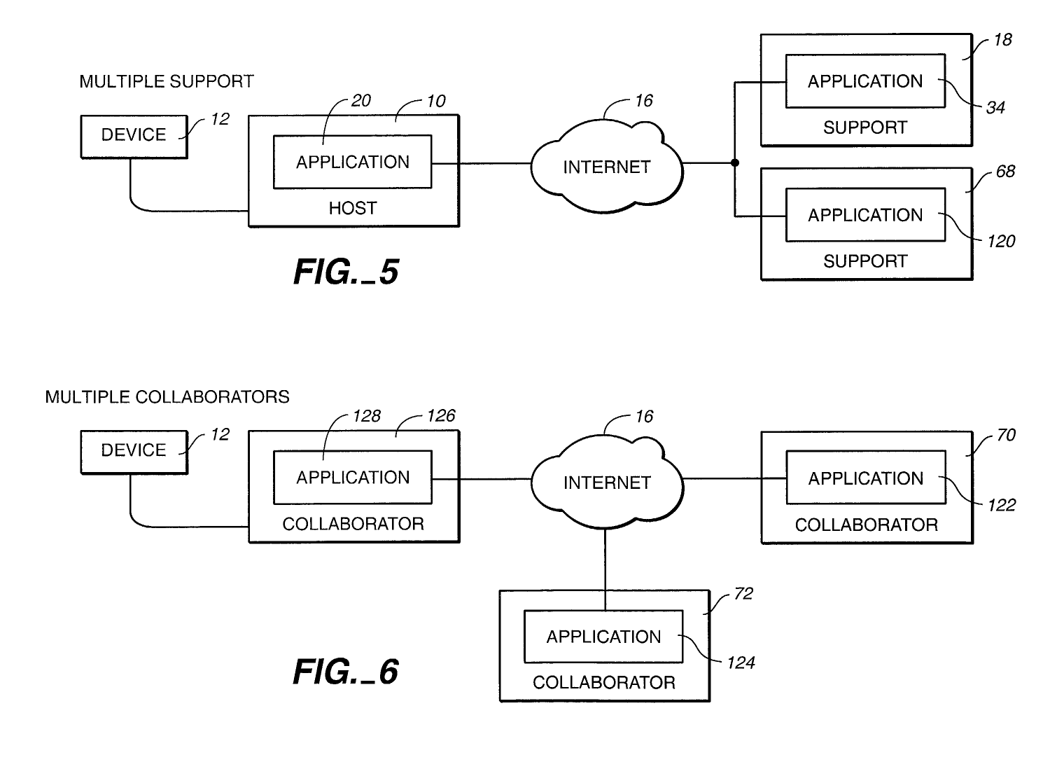

As shown in FIG. 5, the customer support embodiment of the invention allows a customer's computer's 10 software application 20 to be linked via the Internet 16 with multiple support computers' 18, 68 software applications 34, 120. Before establishing the connection, the new customer support application 120 must be configured to reflect that it has no device 12 attached. (In the current embodiment, this can be done on the command line to start the application.) This new application 120 would also have to be configured to be client-side software since connections are established with the application configured as a server. The new customer support application 120 user would then specify the TCP/IP address of the original support computer and request that a connection be established. Once the connection is established, the customer support specialist using the second support computer 68 will be able to interact with the software 20 and any attached device 12 with equal priority to the other two applications 20, 34. Messages are passed between the linked applications 20, 34, and 120 as shown FIGS. 2, 3, and 4. The number of customer support specialists who may be linked is limited only by the application's programming. Although the device 12 is described here and shown in FIG. 5 as attached to the customer's computer 10, the device 12 can be attached to either a server or one of the multiple clients (provided only one client indicates that it attached to a hardware device 12).

In FIG. 6, an alternative embodiment is shown where multiple collaborators at geographically remote locations can be linked via the software applications 122, 124, 128 running on their computers 70, 72, 126. One of the collaborators' applications 122, 124, 128 should be configured as server-side software while the others should be configured as clients. Connections are established as discussed above and messages are passed as shown in FIGS. 2, 3 and 4.

The preceding discussion has focused on the remote control of a software application and an attached hardware or software device. However, the concepts discussed above are applicable to remote control of a software application even where no hardware or software device is attached to the host computer.

In another embodiment, the invention can be implemented with a predominantly message-driven architecture instead of the read and transmit threads described above. While at least one thread still must be used to monitor whether the core component has responded to a wait command, messages may be passed among different components and modules without the use of threads when a message-driven architecture is employed.

1. In a communications network, a system for enabling both a host computer and a remote computer to view and control a software application controlling a hardware or software device running on the host computer, said system comprising:
a) a host computer running a software application, said software application having:
i) a core component controlling both the operation of the software application and a device attached to the computer;
ii) a graphical user interface presenting output from and accepting input to the software application;
iii) a communication module handling messages passed between the core component and the graphical user interface;
iv) a client/server module having a socket allowing bi-directional communications with other instances of said software application running on other computers in a network; and
v) a thread to monitor whether the core component has responded to a wait command; and
b) a remote computer running another instance of the software application, said software application connected to the host computer's software application by a TCP/IP connection;
wherein the host computer's software application and the remote computer's software application share information and control of both the software application running on the host computer and the hardware or software device connected to the host computer.

2. The system of claim 1 wherein the device is a hardware device.

3. The system of claim 2 wherein the hardware device is a microprocessor.

4. The system of claim 2 wherein the hardware device is an in-circuit emulator.

5. The system of claim 2 wherein the hardware device is a data storage device.

6. The system of claim 2 wherein the hardware device is a test instrument.

7. The system of claim 2 wherein the hardware device is an internet-enabled appliance.

8. The system of claim 1 wherein the device is a software device.

9. The system of claim 8 wherein the software device is a simulator.

10. The system of claim 1 wherein the host computer software application is configured as server-side software and the remote computer software application is configured as client-side software.

11. The system of claim 1 wherein the host computer software application is configured as client-side software and the remote computer software application is configured as server-side software.

12. The system of claim 1 wherein the TCP/IP connection is initiated by the software application configured as client-side software.

13. The system of claim 1 wherein a user of the remote computer is providing customer support to a user of the host computer.

14. The system of claim 1 wherein a user of the host computer is providing customer support to a user of the remote computer.

15. The system of claim 1 wherein a user of the remote computer is collaborating on a project with a user of the host computer.

16. The system of claim 1 wherein the computer running the software application which has been configured as client-side software is located behind a firewall or a similar Internet security device.

17. The system of claim 1 wherein the software application further includes a plurality of threads to pass messages to different components and modules of the software application.

18. The system of claim 17 wherein one of the threads passes messages from a queue in the communication module to the graphical user interface.

19. The system of claim 17 wherein one of the threads passes messages from the core component to a queue in the communication module.

20. The system of claim 17 wherein one of the threads takes messages from the socket and passes them to a queue in the communication module.

21. The system of claim 17 wherein one of the threads takes messages from the socket and passes them to the host software application's core component.

22. The system of claim 1 wherein the software application possesses a message-driven architecture.

23. The system of claim 1 wherein the messages passed by the communication module from the graphical user interface to the core component are commands inputted by one of the users.

24. The system of claim 1 wherein the messages passed by the communication module from the graphical user interface to the core component are requests from one of the users for information about the device.

25. The system of claim 1 wherein the messages passed by the communication module from the core component to the graphical user interfaces concern events that have occurred to the device.

26. The system of claim 1 wherein the messages passed by the communication module from the core component to the graphical user interfaces are responses to the users' request for information.

27. In a communications network, a method for enabling both a host computer and a remote computer to view and control a hardware or software device connected to the host computer and a software application controlling a hardware or software device running on the host computer, said method comprising:
a) connecting a device to a host computer;
b) running the same software application on both a remote computer and the host computer, said software application capable of controlling the device attached to the host computer and having:
i) a core component controlling both the operation of the software application and a device attached to the computer;
ii) a graphical user interface presenting output from and accepting input to the software application;
iii) a communication module handling messages passed between the core component and the graphical user interface; and
iv) a client/server module having a socket allowing bi-directional communications with other instances of said software application running other on other computers in a network; and
v) a thread to monitor whether the core component has responded to a wait command;
c) establishing a TCP/IP connection between the remote software application and the host software application;
d) transmitting commands and events specific to the software application and/or the device over said connection;
e) sharing graphical user interface information between the remote software application and the host software application such that a remote user and host user may provide input to and view output from the software application and the device connected to the host computer which is controlled by said software application running on the host computer; and
f) closing said TCP/IP connection between the remote computer and the host computer at the end of each session.

28. The method of claim 27 wherein the remote user is providing customer support to the host user.

29. The method of claim 27 wherein the host user is providing customer support to the remote user.

30. The method of claim 27 wherein the remote user and the host user are collaborating on a project.

31. The method of claim 27 wherein the software application configured as client-side software initiates the TCP/IP connection with the software application configured as server-side software.

32. The method of claim 27 wherein the software application configured as client-side software shuts down the TCP/IP connection with the software application configured as server-side software.

33. The method of claim 27 wherein the software application configured as server-side software shuts down the TCP/IP connection with the software application configured as client-side software.

34. In a communications network, a system for allowing both a host computer and remote computer to view and control a software application running on the host computer, said system comprising:
a) a host computer running a software application, said software application having:
i) a core component controlling the operation of the software application;
ii) a graphical user interface presenting output from and accepting input to the software application;
iii) a communication module handling messages passed between the core component and the graphical user interface;
iv) a client/server module having a socket allowing bi-directional communications with other instances of said software application running on other computers in a network; and
v) a thread to monitor whether the core component has responded to a wait command; and
b) a remote computer running another instance of the software application, said software application connected to the host computer's software application by a TCP/IP connection;
wherein the host computer and the remote computer share the graphical user interface providing information and control of the software application running on the host computer.

35. The system of claim 34 wherein the host computer software application is configured as client-side software and the remote computer software application is configured as server-side software.

36. The system of claim 34 wherein the host computer software application is configured as server-side software and the remote computer software application is configured as client software.

37. The system of claim 34 wherein the host computer is located behind a firewall or a similar network security device.

38. The system of claim 34 wherein a user of the remote computer is providing customer support to a user of the host computer.

39. The system of claim 34 wherein a user of the host computer is providing customer support to a user of the remote computer.

40. The system of claim 34 wherein a user of the remote computer is collaborating on a project with a user of the host computer.

41. The system of claim 34 wherein the messages passed by the communication module from the graphical user interface to the core component are commands inputted by one of the users.

42. The system of claim 34 wherein the software application further includes a plurality of threads to pass messages to different components and modules of the software application.

43. The system of claim 42 wherein one of the threads passes messages from a queue in the communication module to the graphical user interface.

44. The system of claim 42 wherein one of the threads passes messages from the core component to a queue in the communication module.

45. The system of claim 42 wherein one of the threads takes messages from the socket and passes them to a queue in the communication module.

46. The system of claim 42 wherein one of the threads takes messages from the socket and passes them to the host software application's core component.

47. The system of claim 34 wherein the software application possesses a message-driven architecture.

48. In a communications network, a method for allowing both a host computer and a remote computer to view and control a software application on the host computer, said method comprising:
a) running the same software application on both a remote computer and a host computer, said software application having:
i) a core component controlling the operation of the software application;
ii) a graphical user interface presenting output from and accepting input to the software application;
iii) a communication module handling messages passed between the core component and the graphical user interface; and
iv) a client/server module having a socket allowing bi-directional communications with other computers in a network running other instances of said software application; and
v) a thread to monitor whether the core component has responded to a wait command; and
b) establishing a TCP/IP connection between the remote software application and the host software application;
c) transmitting commands and events specific to the software application and/or the device over said connection;
d) sharing graphical user interface information between the remote software application and the host software application such that a remote user and a host user may provide input to and view output from the software application running on the host computer;
e) shutting down said TCP/IP connection between the remote computer and the host computer at the end of each session.

49. The method of claim 48 wherein the remote user is providing customer support to the host user.

50. The method of claim 48 wherein the host user is providing customer support to the remote user.

51. The method of claim 48 wherein the remote user and the host user are collaborating on a project.

52. The method of claim 48 wherein the software application configured as client-side software initiates the TCP/IP connection with the software application configured as server-side software.

53. The method of claim 48 wherein the software application configured as client-side software shuts down the TCP/IP connection with the software application configured as server-side software.

54. The method of claim 48 wherein the software application configured as server-side software shuts down the TCP/IP connection with the software application configured as client-side software.

55. In a communications network, a system for enabling a plurality of software applications to remotely control and monitor a software application running on a host computer, said system comprising:
a) a plurality of computers; and
b) a plurality of identical software applications running on each of said computers, each instance of said software application having:
i) a core component controlling the operation of the software application;
ii) a graphical user interface presenting output from and accepting input to the software application;
iii) a communication module handling messages passed between the core component and the graphical user interface; and
iv) a client/server module having a socket allowing bi-directional communications with other instances of said software application running on other computers in a network; and
v) a thread to monitor whether the core component has responded to a wait command;
each software application connected to the other software applications via a TCP/IP connection;
wherein each software application can view and control the software application running on a chosen computer.

56. The system of claim 55 wherein one of the computers has a device attached which is controlled by the software application.

57. The system of claim 55 wherein the other connected software applications can view and control the attached device.

58. The system of claim 56 wherein the device is a hardware device.

59. The system of claim 58 wherein the hardware device is an in-circuit emulator.

60. The system of claim 58 wherein the hardware device is a data storage device.

61. The system of claim 58 wherein the hardware device is a test instrument.

62. The system of claim 58 wherein the hardware device is an internet-enabled appliance.

63. The system of claim 58 wherein the hardware device is a microprocessor.

64. The system of claim 56 wherein the device is a software device.

65. The system of claim 64 wherein the software device is a simulator.

66. The system of claim 55 wherein users of a plurality of remote computers are providing customer support to a user of a host computer.

67. The system of claim 55 wherein the user of the host computer is providing customer support to a user of a remote computer.

68. The system of claim 55 wherein users of a plurality of remote computers are collaborating on a project with a user of a host computer.

69. The system of claim 55 wherein the host computer is located behind a firewall or a similar network security device.

70. The system of claim 55 wherein the computer running the software application which has been configured as client-side software is located behind a firewall or a similar Internet security device.

71. The system of claim 55 wherein the messages passed by the communication module from the graphical user interface to the core component are commands inputted by one of the users.

72. The system of claim 55 wherein the messages passed by the communication module from the graphical user interface to the core component are requests from one of the users for information about the device.

73. The system of claim 55 wherein the messages passed by the communication module from the core component to the graphical user interface concern events that have occurred to the device.

74. The system of claim 55 wherein the messages passed by the communication module from the core component to the graphical user interface are responses to the users' request for information.

75. The system of claim 55 wherein the software application further includes a plurality of threads to pass messages to different components and modules of the software application.

76. The system of claim 75 wherein one of the threads passes messages from a queue in the communication module to the graphical user interface.

77. The system of claim 75 wherein one of the threads passes messages from the core component to a queue in the communication module.

78. The system of claim 75 wherein one of the threads takes messages from the socket and passes them to a queue in the communication module.

79. The system of claim 75 wherein one of the threads takes messages from the socket and passes them to the host software application's core component.

80. The system of claim 55 wherein one of the software applications is configured as a server-side software.

81. The system of claim 80 wherein the remainder of the software applications are configured as client-side software.

82. The system of claim 55 wherein the software application possesses a message-driven architecture.
